(19) United States
(12) Patent Application Publication
(10) Pub. No.: US 2018/0263231 A1
(43) Pub. Date: Sep. 20, 2018

(54) FISH IDENTIFICATION APPLICATION

(71) Applicants: CHAD HARRIS, DOVER, FL (US); JENNIFER HARRIS, DOVER, FL (US)

(72) Inventors: CHAD HARRIS, DOVER, FL (US); JENNIFER HARRIS, DOVER, FL (US)

(21) Appl. No.: 15/892,201

(22) Filed: Feb. 8, 2018

Related U.S. Application Data
(60) Provisional application No. 62/455,717, filed on Feb. 7, 2017.

(51) Int. Cl. A01K 99/00; G06F 17/30; G06Q 30/00; G06K 9/62

(52) U.S. Cl. CPC A01K 99/00; G06F 17/3028; G06T 7/60; G06Q 30/018; G06K 9/6201; G06F 17/30256

(57) ABSTRACT

A system for fish identification and information that includes: a database accessible through a server via a network; a plurality of fish images stored on the database; a software application on a portable electronic device, where the portable electronic device connects to the database via the network to gain access to the plurality of fish images; and an image capture mechanism integrated into the portable electronic device where the image capturing mechanism is adapted to capture a first image for comparison with images within the plurality of fish images. Species verification is accomplished based upon the comparison of the captured fish image with images stored on the database. Further, the database also includes fish and game regulations and confirmation of fish and game regulation compliance upon species verification.

### CROSS REFERENCE TO OTHER APPLICATIONS

This application claims priority to U.S. Provisional Application Ser. No. 62/455,717 filed on Feb. 7, 2017.

### BACKGROUND OF THE INVENTION

### Field of Invention

The present invention relates to a fish identification application to identify fish species.

### Description of Related Art

Fishing is a common pastime where fishermen partake in catching fish in various bodies of water. Fishermen fish in lakes, rivers, streams and oceans throughout the country. Fishing is a regulated activity, where a fishing license must be obtained and particular guidelines have been established with respect to the catching of fish. As a result, it is important to be able to identify and classify any fish that is obtained from a particular body of water. Limits on the number of fish caught and also concerns about protected fish requires fishermen to be knowledgeable of the type of fish they are obtaining from a particular body of water. Further it is important to know certain species of fish may be poisonous and therefore avoided while fishing. Other aspects of fishing relate to knowledge of the regulations in terms of size, weight and quantity of fish that may be obtained while fishing. Further certain fish are available for fishing in certain seasons and other limitations may be related to fishing data a fisherman must have knowledge of. As a result, it would be advantageous to have an application that could assist a fisherman in identifying the species of a fish and provide ready access to information regarding fishing regulations.

### SUMMARY OF THE INVENTION

The present invention relates to a system for fish identification and information that includes: a database accessible through a server via a network; a plurality of fish images stored on the database; a software application on a portable electronic device, where the portable electronic device connects to the database via the network to gain access to the plurality of fish images; and an image capture mechanism integrated into the portable electronic device where the image capturing mechanism is adapted to capture a first image for comparison with images within the plurality of fish images. Species verification is accomplished based upon the comparison of the captured fish image with images stored on the database. Further, the database also includes fish and game regulations and confirmation of fish and game regulation compliance upon species verification.

### BRIEF DESCRIPTION OF DRAWINGS

FIG. 1 depicts a system for fish identification according to the present invention.

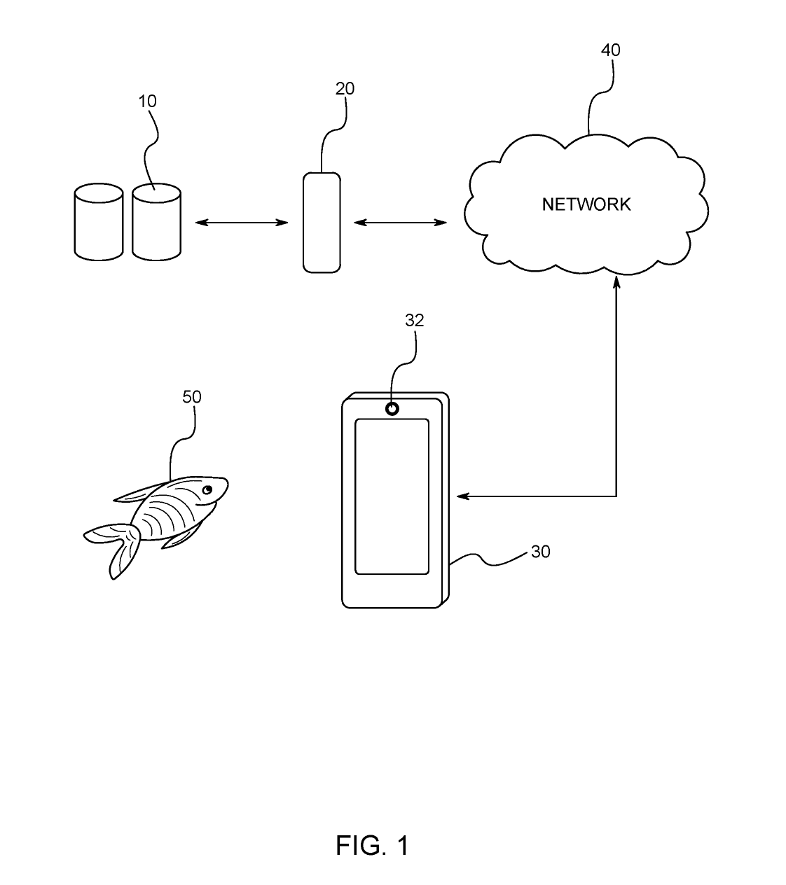

### DETAILED DESCRIPTION

The present invention relates to a system and method for fish identification implemented on a user's portable electronic device. Preferably the portable electronic device has an image capturing mechanism such as a camera integrated into the portable electronic device. The camera may be available to capture an image of a particular fish and then compare that image to a plurality of fish images stored on a database. A matching process is implemented to match an image is located in the fish image database through use of the application. Once the matching is complete the user is provided notice of the species of fish that is requested.

Another aspect of the application includes information regarding fish and game regulations and guidelines regarding fishing. A user may access this information as needed so that they have accurate information regarding fishing regulations. The present invention provides an active platform to engage the user with the appropriate information concerning fishing. In addition to general fishing information, the users may also create profiles and user names in order to interact with other fishermen with other aspects of fishing. Specific exchange of recipes, bait use or other techniques to assist in fishing and enjoyment of fish after the catch.

The application further provides measurement estimates associated with the subject fish. A scaling image is provided in the application to give the user a general weight estimate based upon the size of the fish. The scaling image also provides an estimated length of the fish. The user may also store an image of the photo on a database. The stored image may include a schematic of the fish within the image.

The present invention provides a system for fish identification and information through a database 10 accessible through a network 40. The database 10 includes a plurality of fish images for comparison purposes. Further stored on the database 10 are fish and game regulations regarding fishing regulations regarding a particular jurisdiction. Multiple jurisdictions may be stored within the database 10 so the user may use the application at various locations as needed. A server 20 provides secure access to the database 10 through network 40. A software application stored on a portable electronic device 30 such as a smart phone or a tablet allows the user to access information on the database. The user may access general information regarding fishing regulations, fish types and fishing techniques needed. Further the user may capture an image using a camera 32 on the portable electronic device (PED) 30 and compare this image to the images available on the database. The present invention allows a user to identify a fish 50 by comparing an image of the fish 50 taken by the PED 30 and comparing to images stored in and the database 30. A user gains immediate verification of fish species and compliance with fish and game regulations regarding the species. The instant invention has been shown and described in what it considers to be the most practical and preferred embodiments. It is recognized, however, that departures may be made there from within the scope of the invention and that obvious modifications will occur to a person skilled in the art.

What is claimed is:

1. A system for fish identification and information comprising:
a database accessible through a server via a network;
a plurality of fish images stored on the database;
a software application on a portable electronic device, where the portable electronic device connects to the database via the network to gain access to the plurality of fish images; and
an image capture mechanism integrated into the portable electronic device where the image capturing mechanism is adapted to capture a first image for comparison with images within the plurality of fish images.

2. The system according to claim 1, wherein the database includes fish and game regulations.

3. The system according to claim 2, further including species verification based upon the comparison of images.

4. The system according to claim 3, further including confirmation of fish and game regulation compliance upon species verification.
